(19) United States
(12) Patent Application Publication
(10) Pub. No.: US 2019/0292759 A1
(43) Pub. Date: Sep. 26, 2019

(54) METHOD AND APPARATUS FOR REMOVING DRAIN CLOG

(71) Applicants: ELIZABETH DANIELS SOLOMON PARKER, TITUSVILLE, FL (US); JOHN CHARLES BESS, DOVER, KY (US)

(72) Inventors: ELIZABETH DANIELS SOLOMON PARKER, TITUSVILLE, FL (US); JOHN CHARLES BESS, DOVER, KY (US)

(21) Appl. No.: 15/936,388

(22) Filed: Mar. 26, 2018

(51) Int. Cl. E03C 1/302; B08B 9/04; B25G 1/10

(52) U.S. Cl. CPC E03C 1/302; C08L 2201/06; B25G 1/10; B08B 9/04

(57) ABSTRACT

The present invention provides an improved apparatus and method for removing clogs from a drain pipe. The apparatus includes a drain snake with a handle and barbs for snagging any material that is clogging the drain pipe. It also includes a protective cowl, constructed like a bellow, that includes a thumb ring, to completely cover the drain snake. The drain snake and the protective cowl are both made of a biodegradable material that will be innocuously being broken down over a period of time. Once the clogging material along with any residual material is removed, including any dirty liquids, along with the drain snake and the protective cowl are placed in a trash bin to biodegrade.

### FIELD OF THE INVENTION

The present invention generally relates to unclogging of drains, and particularly to a method and apparatus for unclogging of drains. The apparatus comprises a biodegradable snake bellows-constructed cowl with a thumb ring.

### BACKGROUND OF THE INVENTION

It has long been known that because of the shapes of drain pipes, more often material such as human or animal hair may end up going down the pipe, and create a clog that may require an apparatus such as a snake for dislodging clogs in drainpipes. Normally, the snake is made of a plastic material, flexible-enough to go down the pipe. Once a drainpipe clog is dislodged, the snake along with the dislodged material, and possibly some dirty back-up water is pulled by the user.

Through the years, a myriad of inventors came up with one solution or another to said drain clogging problems. One example is U.S. Pat. No. 9,217,243 to Gwen, whereby the tool for cleaning a drain includes a handle, a strip member, and an end piece. The handle inserts and removes the tool from the drain. The strip member has an elongated and undulated shape and is formed by segments. Each segment has a curvature with a concave side and convex side, which alternate from adjacent segments. Each segment also has barbs on each concave side. The barbs are shielded by an adjacent convex side of an adjacent segment. The end piece connects to a bottom segment of the strip member and has a collar and tip. The collar has a protective shoulder to shield barbs of the bottom segment and an actuatable spike to collect debris when bent. The tip has a distal point with prongs and a distal shoulder, which shields the prongs. The tip may also include a shaft with shaft barbs protected by a shaft shoulder.

Another example is U.S. Pat. Pub. No. 2016/0221050 to Beck, whereby a drain cleaning apparatus, includes a handle and a clog-catching member detachably connected the handle. Airplane-like wings project radially from the clog-catching member. The wings provide an angled projection that catches and holds a clump of debris in a drain pipe for unclogging the drain. Clog-catching members or smooth extension members can be connected end to end for different lengths. Different end tools can be removably connected to a clog catching member or to a smooth extension member to provide multi-functionality. A drain cleaning harpoon that is an integral unit or one that can be assembled and disassembled is also provided. The harpoon can be fitted on one end with a plurality of J hooks, fish hooks, arrowheads or retractable barbs for catching and holding a mass of debris in a drain pipe.

Despite these and other earlier works, there is still no adequate system for cleanly removing the debris, along with any back-up dirty water.

### SUMMARY OF THE INVENTION

The present invention relates to an apparatus for removing clogs in sinks and shower drains found in homes, offices, hotels, airport facilities, and other similar facilities. Specifically, the apparatus of the present invention prevents the user from having a physical contact with the clogging material and backed-up liquid that comes out during removal of the clog.

In a first embodiment the present invention provides a tool known as a drain snake, such a drain snake is created from a biodegradable material that will be innocuously being broken down over a period of time.

In a second embodiment the present invention provides a protective cowl, constructed like a bellow, that includes a thumb ring, to completely cover the biodegradable drain snake.

In a third embodiment, the present invention provides a complete apparatus for removing clogs, including a protective cowl encasing a biodegradable drain snake along with the obstructing material which is removed and placed in a trash bin.

The fourth embodiment may further comprise a method for safely removing a clogging material along with any residual material, including dirty liquids, placing it in a trash bin.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1(a) provides a side view of a biodegradable drain snake in accordance with a first embodiment of the present invention.

FIG. 1(b) provides a bottom view of a biodegradable drain snake in accordance with a first embodiment of the invention

FIG. 2(a) provides a front view of translucent bellows-shaped cowl in accordance with the second embodiment of the present invention.

FIG. 2(b) provides a top view of translucent bellows-shaped cowl in accordance with the second embodiment of the present invention.

FIG. 3(a) provides a complete apparatus, including a translucent bellows-shaped cowl, and a biodegradable drain snake inserted therein, in accordance with the third embodiment of the present invention.

FIG. 3(b) provides a top view of translucent bellows-shaped cowl prior to the insertion of a biodegradable drain snake in accordance with the third embodiment of the present invention.

### DETAILED DESCRIPTION OF THE INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

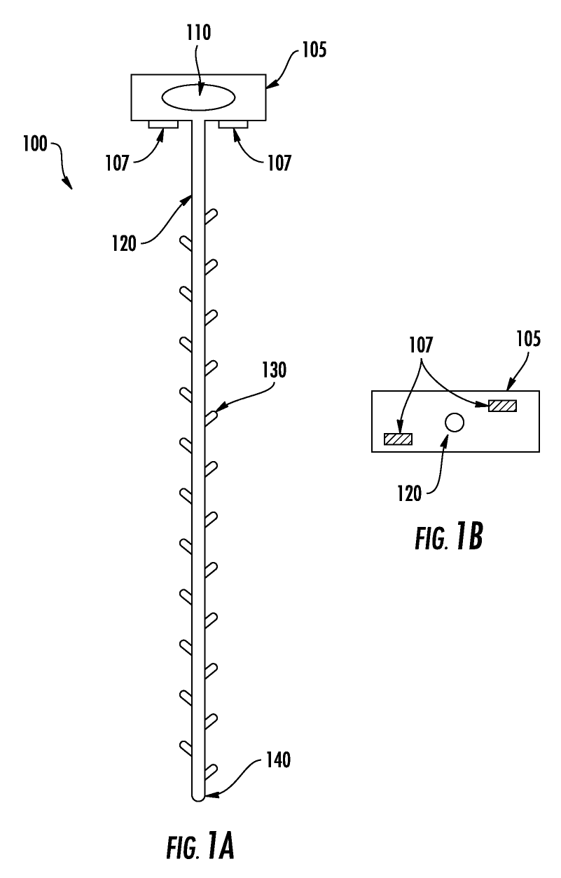

Detailed reference will now be made to embodiments of the present invention, examples of which are illustrated in FIGS. 1 through 3. In a first embodiment, a biodegradable drain snake 100 is formed as a single unit and is made of a biodegradable material, it includes a shaft 120 and a handle 105, that includes an opening 110, large enough to accommodate a user's hand. The biodegradable drain snake 100, also includes spaced-apart, sharp-tipped, long, thin, flexible, barbs 130 that are attached on each side of shaft 120. The barbs 130, are placed at 45 degree angles from the shaft 120, in order to facilitate grabbing and pulling of all and any other obstructing material.

In a first embodiment the present invention, and in reference to FIG. 1, the embodiment provides a tool known as a drain snake, such a drain snake 100 is created from a biodegradable material that will be innocuously being broken down over a period of time.

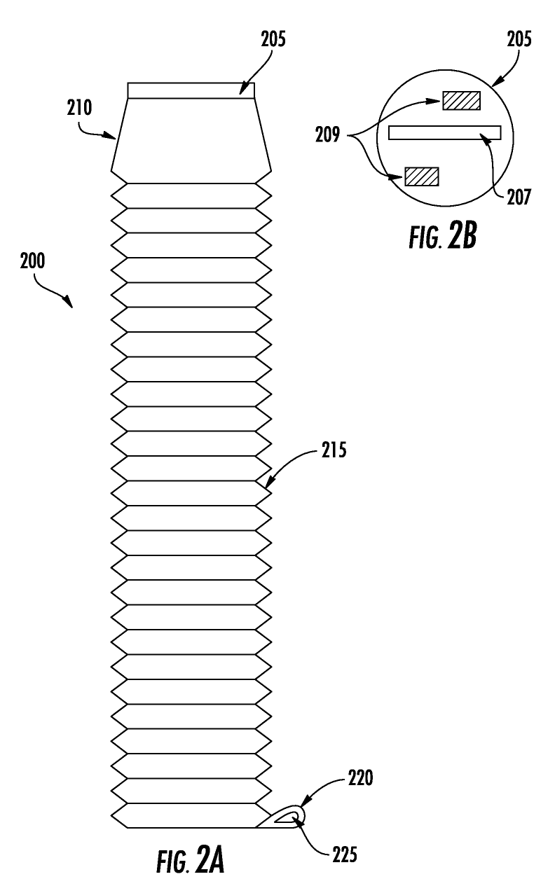

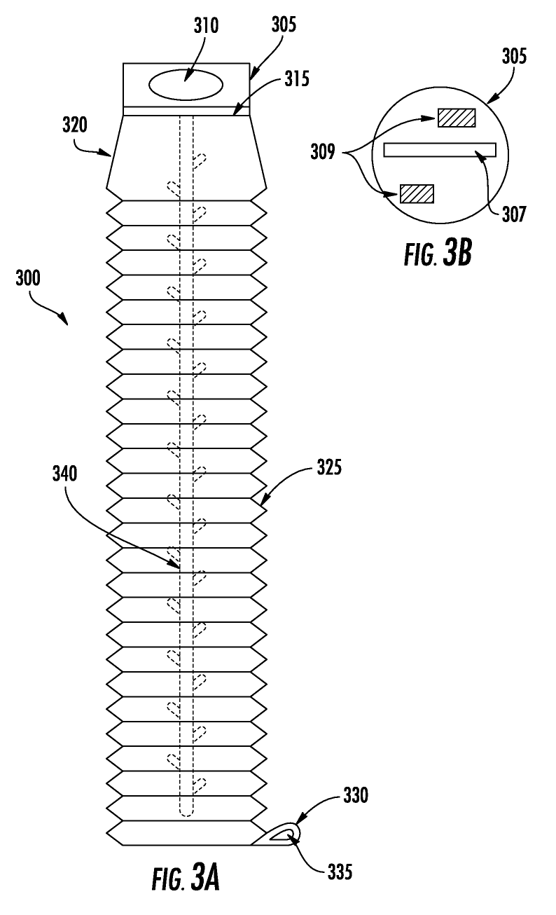

The drain snake 100 is further defined with a tip 140 which is adaptively used to break up a blocking object within a drainpipe. The shaft 120 is the flexible component of the drain snake 100 that connects the handle 105 to the rest of the body, including the barbs 130. The handle 105 of the drain snake 100 also includes an adhesive, possibly in the form of a two-sided tape or a Velcro™ 107, attached to the bottom of the handle 105 (see FIGS. 1(a) and (b)), and designed to stick the bottom surface of the drain snake 100, onto a top surface of the translucent bellows-shaped cowl 209 (see FIG. 2(b)) during the use of the whole unit (see FIG. 3(a)), and in order to keep the drain snake 100 and the translucent bellows-shaped cowl 200 attached together during operation.

In the second embodiment the present invention, and in reference to FIG. 2, the embodiment provides a biodegradable translucent bellows-shaped cowl 200, which acts like an accordion 215. The reason that the biodegradable translucent bellows-shaped cowl 200 is made from a translucent material is because it allows the user to visually see the blocking material that has been pulled from the drain. It includes a top portion 205, in which there is an opening 207, large enough to accommodate the drain snake 100. At the bottom of the biodegradable translucent bellows-shaped cowl is a thumb ring 220, with an opening 225 for the user's finger or thumb for pulling a string (not shown) attached to it. The thumb ring 220 includes a string (not shown) that spans the bottom circumference of the biodegradable translucent bellows-shaped cowl 200, which when pulled by the user, closes the bottom of the biodegradable translucent bellows-shaped cowl 200, in order to confine the obstructing or any other offending material from spilling out. In addition, the thumb ring 220 keeps the bellows-shaped cowl 200 in place against the outer diameter of the drain, when the drain snake 100 is pulled out of the drain.

In the third embodiment the present invention, and in reference to FIG. 3, the embodiment provides an entire biodegradable apparatus for removing a clog from a drain, and it includes a biodegradable translucent bellows-shaped cowl 325, which acts like an accordion, thereby allowing a user to fold it down when the biodegradable snake drain 340 is being pushed down the drain to be unclogged. To operate the apparatus of the present invention, a user fully inserts the biodegradable drain snake 340 into the biodegradable translucent bellows-shaped cowl 325 until the two pieces are flushed with each other, and further into the drain that has an obstructing material. And to ensure that biodegradable drain snake 340 and the biodegradable translucent bellows-shaped cowl 325 stay together, an adhesive 309 on the top portion of the biodegradable translucent bellows-shaped cowl 325, and an adhesive (see FIG. 1, #107) are affixed together thereby creating a single unit; the adhesive on both the translucent bellows-shaped cowl 325, and the biodegradable drain snake 305, are affixed on two adjacent spots. After pulling out the offending material, the biodegradable drain snake 340 and the biodegradable translucent bellows-shaped cowl 325, are dropped into a trash bin in order to dispose of the offending material along with the apparatus of the present invention.

The reason that the bellows-shaped cowl 325 is made from a translucent material is because it allows the user to see the blocking material that has been pulled from the drain by the drain snake 320. It includes a top portion 315, in which there is an opening 307, large enough to accommodate the drain snake 320. At the bottom of translucent bellows-shaped cowl 325 is a thumb ring 330, for the user's finger or thumb with an opening 335 for pulling and closing the translucent bellows-shaped cowl 325. The thumb ring 330 includes a string (not shown) that spans the bottom circumference of the biodegradable translucent bellows-shaped cowl 325, which when pulled by the user, closes the bottom of the biodegradable translucent bellows-shaped cowl 325, in order to confine the obstructing or any other offending material from spilling out. The user pulls on the thumb ring 320 in order to close the bottom of the translucent bellows-shaped cowl 325 to ensure that all the offending material stays inside the translucent bellows-shaped cowl 325 for removal and to be disposed of.

In operation, the user (not shown) inserts the drain snake 100 into the clogged drain in order to penetrate the clogging material, be it hair, food particles, or any other offending material. The user applies a push-and-pull motion to free up the clogging material. The barbs 130 are designed to be activated as the shaft bends within the clogged pipe, allowing it to flexibly conform to the shape of the pipe, so as to allow the snagging and holding of any obstructing material, thereby allowing it to be safely removed. After the biodegradable drain snake's shaft 340 is completely inserted into the biodegradable translucent bellows-shaped cowl 325, the single unit is deployed and held in place by the thumb ring 330 against the mouth of the basin of the clogged drain. The shaft 340 is then slowly withdrawn from the drain pipe, carrying along the clogging material that has been snagged by the barbs; such a motion elongates the biodegradable translucent bellows-shaped cowl 325 in order to accommodate the length of the shaft 320. The biodegradable translucent bellows-shaped cowl 325 lengthens and compresses in an accordion fashion until the shaft 340 and the obstructing material is completely removed from the drain pipe and fully encased. Once the shaft 340 has cleared the drain pipe, the user pinches biodegradable translucent bellows-shaped cowl 325 closed by pulling the thumb ring 330, and lifts the end of the biodegradable translucent bellows-shaped cowl 325, so the open end faces upward, forming a “U” shape. The fully extended biodegradable translucent bellows-shaped cowl 325 completely encases the shaft 320, and the obstructing material, preventing splatter of residual matter and liquids from escaping the biodegradable translucent bellows-shaped cowl 325. The entire biodegradable device may then be discarded into a trash receptacle.

While the invention has been described by reference to certain preferred embodiments, it should be understood that numerous changes could be made within the spirit and scope of the inventive concept described. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A method for removing a clog from a drain, comprising:
inserting a biodegradable drain snake into a biodegradable translucent bellows-shaped cowl;
affixing said biodegradable drain snake onto said biodegradable translucent bellows-shaped cowl, with the aid of an adhesive;
moving said biodegradable drain snake in a downward motion followed by an upward motion through said biodegradable bellows-shaped cowl, and further into said drain, in order to dislodge any obstructing material; and
disposing of the biodegradable drain snake, the biodegradable translucent bellows-shaped cowl, along with any removed obstructing material into a trash bin to properly discard them all.

2. The method of claim 1, wherein the affixing is achieved with use of a two-way tape, Velcro™, or similar adhesive.

3. The method of claim 2, wherein the two-way tape, Velcro™, or similar adhesive is affixed on two places at a bottom of a handle of the biodegradable drain snake.

4. The method of claim 2, wherein the two-way tape, Velcro™, or similar adhesive is affixed on two places on a top surface of the biodegradable, translucent bellows-shaped cowl.

5. The method of claim 1, wherein after affixing the biodegradable drain snake onto said biodegradable bellows-shaped cowl creating a single piece unit

6. The method of claim 1, wherein the dislodged obstructing material may be visually seen through the biodegradable, translucent bellows-shaped cowl.

7. The method of claim 1, wherein keeping the biodegradable, translucent bellows-shaped cowl becomes flush with a mouth of said drain is achieved with a thumb ring.

8. The method of claim 1, wherein pinching the biodegradable translucent bellows-shaped cowl to close by pulling the thumb ring, and lifting the end of the biodegradable translucent bellows-shaped cowl along with the biodegradable snake drain and the material removed to dispose of all.

9. An apparatus for removing a clog from a drain, comprising:
a biodegradable drain snake inserted into a biodegradable translucent bellows-shaped cowl;
said biodegradable drain snake being affixed onto said biodegradable translucent bellows-shaped cowl, with the aid of an adhesive;
said biodegradable drain snake being moved in a downward motion followed by an upward motion through said biodegradable bellows-shaped cowl, and further into said drain, in order to dislodge any obstructing material; and
the biodegradable drain snake, the biodegradable translucent bellows-shaped cowl, along with any dislodged obstructing material removed being disposed of into a trash bin to properly discard them all.

10. The apparatus of claim 9, wherein a two-way tape, Velcro™, or similar adhesive is used for affixing.

11. The apparatus of claim 10, wherein the two-way tape, Velcro™, or similar adhesive is affixed on two places at a bottom of a handle of the biodegradable drain snake.

12. The apparatus of claim 10, wherein the two-way tape, Velcro™, or similar adhesive is affixed on two places on a top surface of the biodegradable, translucent bellows-shaped cowl.

13. The apparatus of claim 9, wherein the biodegradable drain snake and the said biodegradable bellows-shaped cowl are affixed together thereby creating a single piece unit

14. The apparatus of claim 9, wherein the biodegradable, translucent bellows-shaped cowl allows the user to visualize the dislodged obstructing material.

15. The apparatus of claim 9, wherein keeping the biodegradable, translucent bellows-shaped cowl is made flush with a mouth of said drain by using a thumb ring.

16. The apparatus of claim 9, wherein the biodegradable translucent bellows-shaped cowl is pinched to close it by pulling the thumb ring, and lifting the end of the biodegradable translucent bellows-shaped cowl along with the biodegradable snake drain and the material removed to dispose of all.
